(19) United States
(12) Patent Application Publication
(10) Pub. No.: US 2026/0324586 A1
(43) Pub. Date: Oct. 22, 2026

(54) ANIMAL FEEDER AND A CONTROL METHOD THEREOF

(71) Applicant: Shenzhen Xunmian Technology Co., Ltd., Shenzhen (CN)

(72) Inventor: Xiaojing Li, Shenzhen (CN)

(21) Appl. No.: 19/468,694

(22) Filed: Feb. 3, 2026

(30) Foreign Application Priority Data
Feb. 26, 2025 (CN) 202510219199.5

(51) Int. Cl. A01K 5/02

(52) U.S. Cl. CPC A01K 5/025; A01K 5/0225

(57) ABSTRACT

An animal feeder and a control method thereof comprise a frame, a container, a baffle plate, a rotating structure, a detection mechanism, and a driving mechanism; the detection mechanism and driving mechanism are arranged on the frame. The frame comprises a door frame and a base, the base is provided with a placement groove for placing the container. The baffle plate and base constitute a first blocking area. The rotating structure is arranged on one side of the container and comprises an open position and a closed position. When in closed position, the rotating structure forms a closed space with the base and the baffle plate respectively. When in open position, the rotating structure forms a second blocking area with baffle plate. It has following beneficial effects: when in closed position, the rotating structure and first blocking area enclose the container, preventing animals from contacting container from any direction.

### TECHNICAL FIELD

The invention relates to the technical field of feeders, and more specifically, to an animal feeder and a control method thereof.

### Background Art

In the prior art, an animal feeder is disclosed, which specifically discloses a scheme where an RFID detector is arranged at the entrance of an annular frame. In this scheme, one side of the annular frame is an open entrance to facilitate authorized animals to eat, while the other side is formed by a left baffle plate, a right baffle plate, and a rear wall to constitute a closed housing to prevent unauthorized animals from contacting the food in the container; moreover, both the container and the cover are located near the side of the closed housing. However, some animals are timid and alert, and are unwilling to put their heads into an annularly enclosed entrance or a closed housing to obtain food from the container.

In another prior art, a pet feeder is disclosed. In this scheme, both sides of the annular frame are open. When the door is in the open position, the authorized pet is in the feeding state. The scheme uses a triangular baffle plate and the door structure to restrict animals from approaching the food container from the front, but it still cannot effectively prevent other unauthorized pets from approaching the food container. Unauthorized pets can easily approach the food container by stepping over the folding door from behind, or crossing or bypassing the triangular baffle plate from the side.

### SUMMARY OF THE INVENTION

The technical problem to be solved by the invention is that sealed and open feeding devices still have different defects. In view of the above defects of the prior art, an animal feeder and a control method thereof are provided.

The technical solution adopted by the invention to solve its technical problem is as follows:
an animal feeder and a control method thereof comprises a frame, a container, a baffle plate, a rotating structure, a detection mechanism, and a driving mechanism;
the frame comprises a door frame and a base, the base is connected to the door frame, the base is provided with a placement groove for placing the container;
the baffle plate is arranged corresponding to the base, and the baffle plate is connected to both the base and the door frame, forming a first blocking area with the base;
the rotating structure is arranged on one side of the container and is pivotally connected to the door frame;
the rotating structure comprises an open position and a closed position;
when the rotating structure is in a closed position, the rotating structure forms a closed space with the base and the baffle plate respectively, so that the container is located within the closed space;
when the rotating structure is in a open position, the rotating structure forms a second blocking area with the baffle plate, allowing animals to only contact the container by passing through the door frame;

Further, the limiting structure at least comprises a first limiting member and a second limiting member, and is used to restrict the movement of the movable baffle.
the detection mechanism is arranged on the frame and is electrically connected to the driving mechanism;
the driving mechanism is arranged inside the frame to drive the rotating structure to move to the open position or the closed position.

Further, the rotating structure comprises a movable baffle, a rotating shaft, and a limiting structure, the limiting structure is connected to the rotating shaft, the movable baffle moves around the rotating shaft, and the movable baffle is arc-shaped.

Further, when the rotating structure moves to the closed position, the movable baffle moves downward around the rotating shaft, and front and rear edges of the movable baffle respectively coincide with edges of the baffle plate and the base, so that the container is within the closed space;

when the rotating structure moves to the open position, the movable baffle moves upward around the rotating shaft, so that the container is in an open state.

Further, the detection mechanism at least comprises an infrared detection device and a tag identification device, the infrared detection device is arranged on the frame;

the tag identification device is located at a bottom of the frame or on the door frame;

the tag identification device is used to drive the operation of the driving mechanism.

Further, the driving mechanism comprises a geared motor and driving wheels; the driving wheels abut against the rotating structure, the geared motor is used to drive the movement of the driving wheels to drive the rotation of the rotating structure.

Further, the base is provided with a fixing block, the fixing block is provided with a first inclined surface; the geared motor and the driving wheels are arranged inside the fixing block, the driving wheels protrude from the first inclined surface and abut against the movable baffle.

The invention also provides an animal feeding device, comprising the animal feeder disclosed in the embodiments of the invention.

The invention further proposes a control method for the animal feeder, comprising: establishing a communication connection between a preset infrared detection device and a preset tag identification device;

collecting signals by the infrared detection device;

receiving the signals and starting the operation of the tag identification device;

collecting data by the tag identification device; wherein the data comprises authorized data, unauthorized data, and blank data;

unauthorized data, and blank data;

receiving the data by a preset read/write device and recording it;

matching the data with a preset database to obtain corresponding instructions;

executing the instructions by the tag identification device.

Further, in the step of matching the data with a preset database to obtain corresponding instructions, the method comprises:
comparing the data with the database by the read/write device;
determining whether the data is consistent with the database;
if yes, matching an opening instruction;
if no, matching a closing instruction.

Further, the method comprises a first phase and a second phase.

When in the first phase, the infrared detection device collects signals until the signals are interrupted, and then starts the operation of the tag identification device;

determining whether the data collected by the tag identification device is consistent with the data in the database;

if yes, matching an opening instruction, and after executing the opening instruction, turning off the tag identification device;

if no, turning off the operation of the tag identification device.

Further, when switching from the first phase to the second phase,

determining whether the signals remain continuously interrupted;

if yes, not turning on the tag identification device, and a preset movable baffle remains in the open state;

if no, turning on the tag identification device to operate for a set time;

within the set time, comparing the data collected by the tag identification device with the data in the database;

if the data collected by the tag identification device is consistent with the data in the database, turning off the tag identification device, the movable baffle remains in the open state, and simultaneously determining whether the signals become interrupted again;

if yes, the movable baffle remains in the open state;

if no, repeating the detection of the second phase

if the data collected by the tag identification device is inconsistent with the data in the preset database, matching a closing instruction, and after executing the closing instruction, turning off the tag identification device;

when the tag identification device has operated for the set time, matching a closing instruction, and after executing the closing instruction, turning off the operation of the tag identification device.

The beneficial effects of the invention are as follows: the door frame of the frame is provided with a detection mechanism, a baffle plate is arranged on the base of the frame, the baffle plate is connected to the door frame and the base respectively, and forms a first blocking area with the base; the base is provided with a placement groove for placing the container, the rotating structure is arranged above the container, and the rotating structure comprises an open position and a closed position; when the rotating structure is in the closed position, the rotating structure and the first blocking area form a closed space, and the container is located within the closed space, preventing animals from contacting the container from any direction; when the rotating structure is in the open position, the rotating structure moves upward, making the container completely open, and forms a second blocking area with the baffle plate to further block the upper area of the first blocking area, preventing animals from contacting the container from above the first blocking area, and allowing animals to only contact the container by passing through the door frame to obtain food, thereby avoiding the situation where some timid and alert animals are unwilling to put their heads into an annularly enclosed entrance or a closed housing to obtain food from the container.

### BRIEF DESCRIPTION OF ACCOMPANY DRAWINGS

FIG. 1 is a perspective view of an animal feeder in an open position according to an embodiment of the invention;

FIG. 2 is a perspective view of a frame of an animal feeder according to an embodiment of the invention;

FIG. 3 is a left view of a frame of an animal feeder according to an embodiment of the invention;

FIG. 4 is a schematic diagram of the structure of a frame and a baffle plate of an animal feeder according to an embodiment of the invention;

FIG. 5 is a right view of a frame and a baffle plate of an animal feeder according to an embodiment of the invention;

FIG. 6 is a perspective view of an animal feeder in a closed position according to an embodiment of the invention;

FIG. 7 is a schematic diagram of the internal structure of a door frame of an animal feeder according to an embodiment of the invention;

FIG. 8 is a right view of the internal structure of a door frame of an animal feeder according to an embodiment of the invention;

FIG. 9 is a right view of an animal feeder in an open position according to an embodiment of the invention;

FIG. 10 is a perspective view of a driving mechanism of an animal feeder according to an embodiment of the invention;

FIG. 11 is a schematic structural diagram of an animal feeder according to another embodiment of the invention;

FIG. 12 is a perspective view of a food dispensing box according to an embodiment of the invention;

FIG. 13 is a perspective view of an animal feeder according to another embodiment of the invention;

FIG. 14 is an assembly schematic diagram of an animal feeding device according to another embodiment of the invention;

FIG. 15 is a schematic diagram of method steps of a control method for an animal feeder according to an embodiment of the invention.

### REFERENCE SIGNS

Frame 110, Door frame 111, Base 112, Placement groove 1121, Fixing block 1122, First

inclined surface 1123;

Container 120;

Baffle plate 130;

Rotating structure 140, Movable baffle 141, Rotating shaft 142, Limiting structure 143,

First limiting member 1431, Second limiting member 1432;

Detection mechanism 150, Infrared detection device 151, Tag identification device 152;

Driving mechanism 160, Geared motor 161, Driving wheel 162;

First blocking area 170, Second blocking area 180, Food dispensing box 190, Dispensing port 191.

### SPECIFIC EMBODIMENT OF THE INVENTION

To make the objectives, technical solutions, and advantages of the embodiments of the invention clearer, the following will clearly and completely describe the technical solutions in the embodiments of the invention with reference to the accompanying drawings. It is obvious that the described embodiments are part of the embodiments of the invention, rather than all of them. Based on the embodiments of the invention, all other embodiments obtained by those of ordinary skill in the art without creative efforts shall fall within the protection scope of the invention.

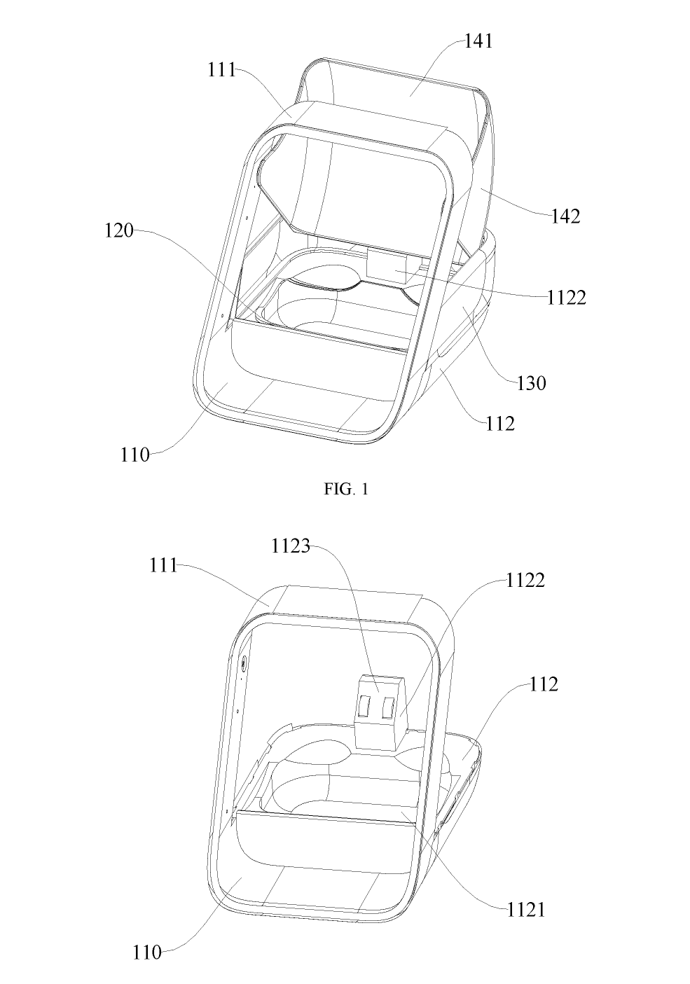

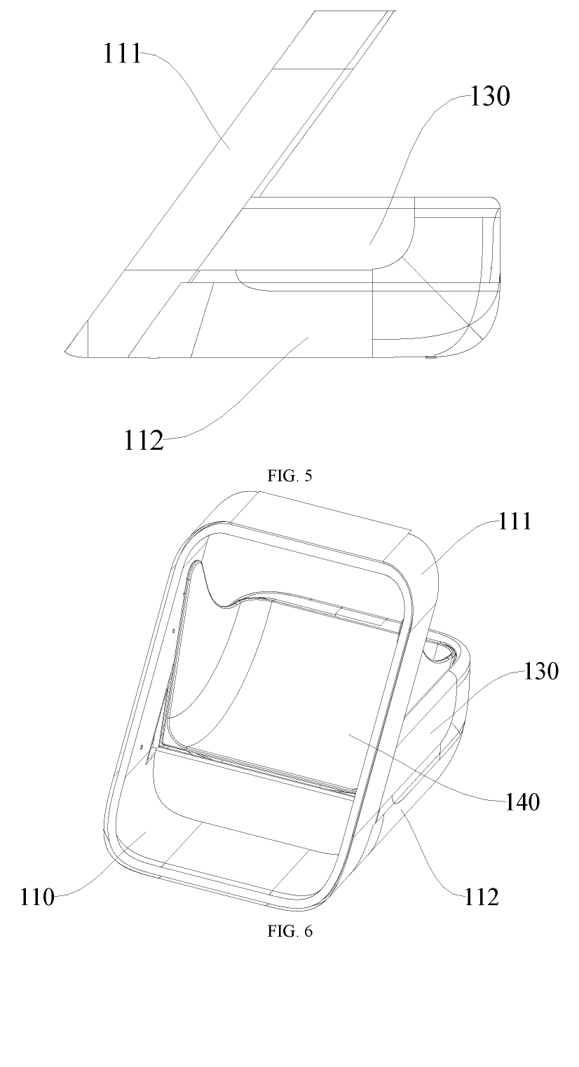

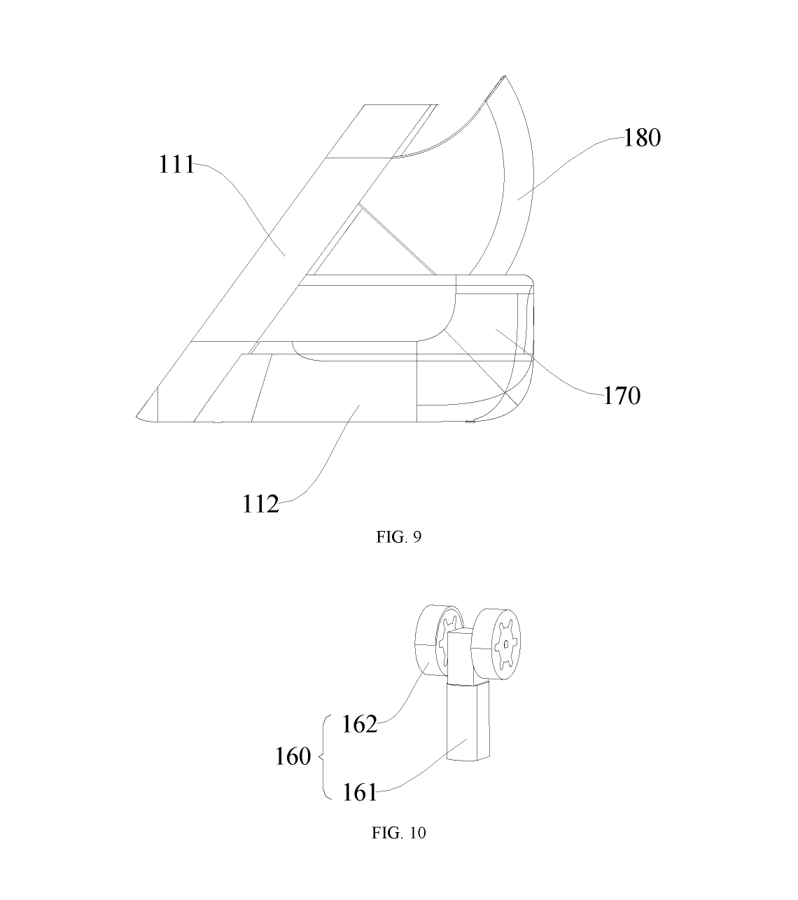

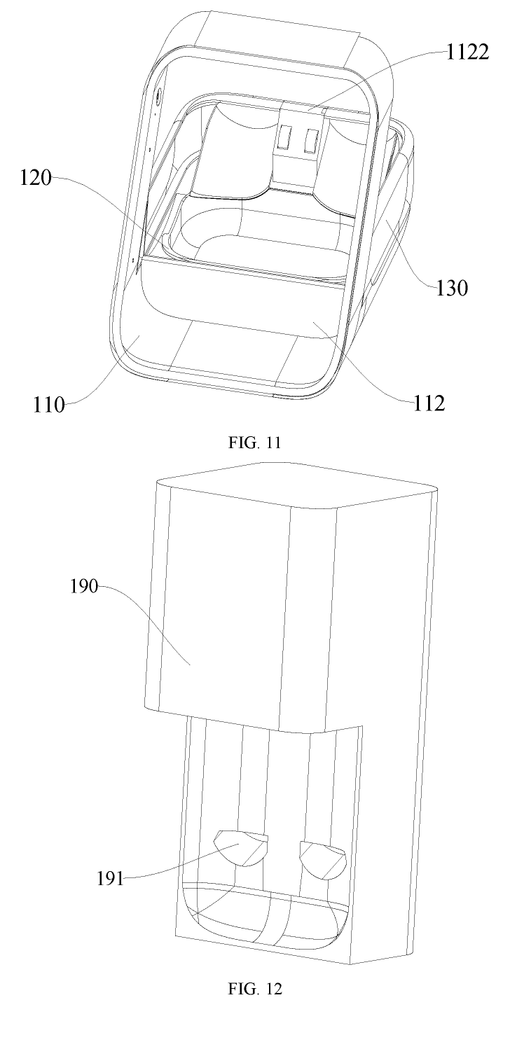

Please refer to FIGS. 1-15 . The invention proposes an animal feeder and a control method thereof, comprising: a frame 110, a container 120, a baffle plate 130, a rotating structure 140, a detection mechanism 150, and a driving mechanism 160; the frame 110 comprises a door frame 111 and a base 112, the base 112 is connected to the door frame 111, the base 112 is provided with a placement groove 1121 for placing the container 120; the baffle plate 130 is arranged corresponding to the base 112 and is connected to both the base 112 and the door frame 111, forming a first blocking area 170 with the base 112, the rotating structure 140 is arranged on one side of the container 120 and is pivotally connected to the door frame 111; the rotating structure 140 comprises an open position and a closed position. When the rotating structure 140 is in the closed position, the rotating structure 140 forms a closed space with the base 112 and the baffle plate 130 respectively, so that the container 120 is located within the closed space. When the rotating structure 140 is in the open position, the rotating structure 140 forms a second blocking area 180 with the baffle plate 130, allowing animals to only contact the container 120 by passing through the door frame 111; the detection mechanism 150 is arranged on the frame 110 and is electrically connected to the driving mechanism 160; the driving mechanism 160 is arranged inside the frame 110 to drive the rotating structure 140 to move to the open position or the closed position.

In this embodiment, the door frame 111 is arranged on one side of the frame 110, and the base 112 is arranged on an other side of the frame 110, the base 112 is connected to a bottom of the door frame 111, the base 112 is provided with a placement groove 1121, and the container 120 for holding food is placed in the placement groove 1121. In a specific embodiment, the container 120 can be removably taken out for cleaning and disinfection. The baffle plate 130 is arranged on the base 112, and its shape corresponds to the base 112. The baffle plate 130 is connected to both the door frame 111 and the base 112 and forms the first blocking area 170 with the base 112 to block the placement groove 1121, preventing animals from easily contacting the container 120. The rotating structure 140 is located above the container 120 and is pivotally connected to the door frame 111. The rotating structure 140 comprises an open position and a closed position.

When the rotating structure 140 is in a closed position, a movable baffle 141 of the rotating structure 140 forms a closed space with the base 112 and the baffle plate 130 respectively, i.e., the movable baffle 141 forms a closed space with the first blocking area 170, thereby enclosing the container 120 and preventing animals from contacting the container 120 from any direction.

When the rotating structure 140 is in an open position, the movable baffle 141 of the rotating structure 140 moves upward to the open position to ensure that the container 120 is completely open. The movable baffle 141 forms a second blocking area 180 with the baffle plate 130. In a specific embodiment, the portion of the movable baffle 141 in the open position can be higher than the baffle plate 130. The higher portion can provide further blocking of the container 120, preventing animals from contacting the container 120 from above by crossing over the first blocking area 170, allowing animals to only contact the container 120 by passing through the door frame 111. When the baffle plate 130 is higher than the movable baffle 141 of the rotating structure 140, the baffle plate 130 and the base 112 form a semi-enclosed blocking space, which is not conducive to timid or more alert animals obtaining food from the container 120 and increases production costs.

The detection mechanism 150 on the frame 110 is electrically connected to the driving mechanism 160. The detection mechanism 150 at least comprises an infrared detection device 151 and a tag identification device 152. The infrared detection device 151 establishes a communication connection with the tag identification device 152. The tag identification device 152 is electrically connected to the driving mechanism 160, thereby driving the rotating structure 140 to move to the open position or the closed position.

Please refer to FIGS. 6 -8 ,The rotating structure 140 comprises a movable baffle 141, a rotating shaft 142, and a limiting structure 143, the limiting structure 143 is connected to the rotating shaft 142, the movable baffle 141 moves around the rotating shaft 142, and the movable baffle 141 is arc-shaped.

During specific implementation: the movable baffle 141 of the rotating structure 140 is connected to the door frame 111 via the rotating shaft 142. The limiting structure 143 is arranged on the door frame 111. The movable baffle 141 moves around the rotating shaft 142 between the open position and the closed position. The rotating shaft 142 is fan-shaped, making the blocking area of the second blocking area 180 formed by the movable baffle 141 and the baffle plate 130 larger. The movable baffle 141 is arc-shaped, which is more conducive to abutting against a driving wheel 162, avoiding slipping or suspension when the movable baffle 141 contacts the driving wheel 162.

In a specific embodiment, the rotating structure 140 is connected to a bearing, and the bearing drives the movement of the movable baffle 141. The bearing can make the movement of the rotating structure 140 smoother and quieter, but it is more costly and requires a certain structural space.

Please refer to FIGS. 1, 6, 7 and 9, When the rotating structure 140 moves to the closed position, the movable baffle 141 moves downward around the rotating shaft 142, and front and rear edges of the movable baffle 141 respectively coincide with edges of the baffle plate 130 and the base 112, so that the container 120 is within the closed space. When the rotating structure 140 moves to the open position, the movable baffle 141 moves upward around the rotating shaft 142, so that the container 120 is in an open state.

During specific implementation: when the movable baffle 141 moves from the open position to the closed position around the rotating shaft 142, front and rear edges of the movable baffle 141 respectively coincide with the edges of the baffle plate 130 and the base 112. The coincidence is merely a gap relationship to ensure that the container 120 is close to a sealed space, while still leaving a gap to facilitate air circulation within the closed space for the container 120, allowing the smell of the food to dissipate and thereby guiding animals to find the food and eat.

When the movable baffle 141 moves from the closed position to the open position around the rotating shaft 142, the movable baffle 141 moves upward around the rotating shaft 142 to place the container 120 in an open state. One part of the movable baffle 141 abuts against the driving mechanism 160, and another part is higher than the baffle plate 130, forming the second blocking area 180. The first blocking area 170 can enclose the container 120. The combination of the first blocking area 170 and the second blocking area 180 can further protect the feeding animal, preventing other animals from approaching the container 120 from a side or above the base 112.

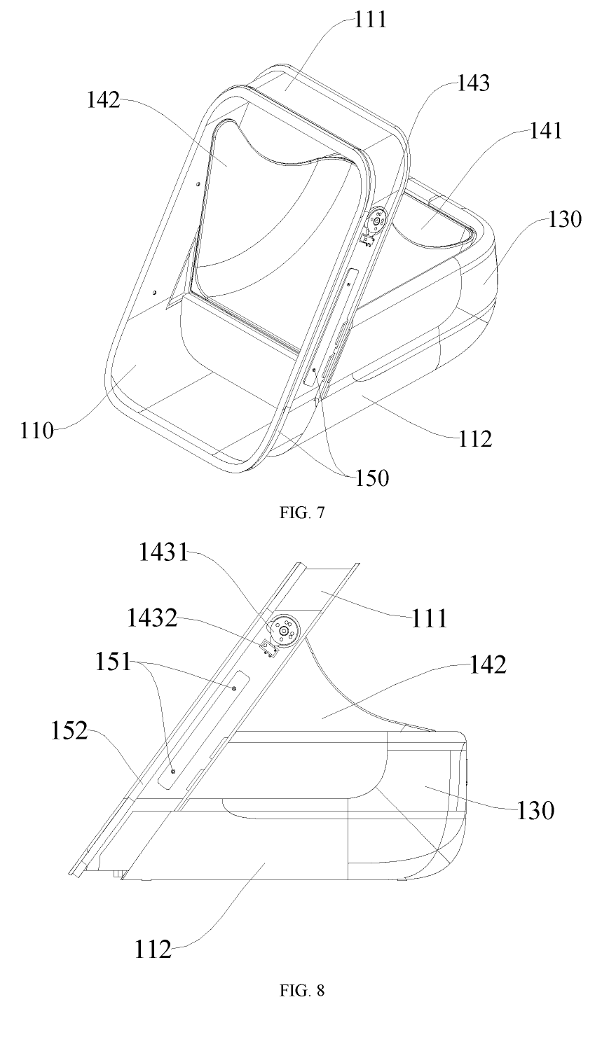

Please refer to FIGS. 7 and 8 . The limiting structure 143 at least comprises a first limiting member 1431 and a second limiting member 1432, and is used to restrict the movement of the movable baffle 141.

During specific implementation: the first limiting member 1431 and the second limiting member 1432 are respectively arranged on the door frame 111. The first limiting member 1431 is connected to the rotating shaft 142, and the first limiting member 1431 is provided with a limiting block. When a geared motor 161 drives the rotating structure 140 to rotate to the open position or the closed position, the second limiting member 1432 abuts against the limiting block of the first limiting member 1431, and blocks the first limiting member 1431 through the second limiting member 1432, thereby limiting the movable baffle 141. The number and shape of the limiting blocks can be adjusted according to actual situations.

Please refer to FIGS. 7 and 8 . The detection mechanism 150 at least comprises an infrared detection device 151 and a tag identification device 152. The infrared detection device 151 is arranged on the frame 110. The tag identification device 152 is located at a bottom of the frame 110 or on the door frame 111. The tag identification device 152 is used to drive the operation of the driving mechanism 160 on the frame 110.

During specific implementation: the infrared detection device 151 is arranged on the frame 110, there are at least two infrared detection devices 151, the tag identification device 152 comprises a controller and a coil; the tag identification device 152 is arranged on the frame 110, specifically at the bottom of the frame 110 or on the door frame 111.

In a specific embodiment, when the door frame 111 on the frame 110 is U-shaped, a coil of the tag identification device 152 is arranged at the bottom of the frame 110, so that the coil of the tag identification device 152 forms a closed loop.

In another specific embodiment, when the door frame 111 on the frame 110 is closed, the coil of the tag identification device 152 is arranged on the door frame 111. The coil of the tag identification device 152 can form a closed loop around the door frame 111. Through the closed coil, the tag can modulate or change the current state of the coil during backscattering, thereby returning the information stored on the tag to the controller, and then driving the operation of the driving mechanism 160 inside the frame 110.

In a specific embodiment, please refer to FIGS. 4, 7 and 8, The infrared detection device 151 is arranged on the door frame 111, specifically on an inner side of the door frame 111, the infrared detection device 151 comprises a transmitter and a receiver, which are symmetrically arranged. The infrared detection device 151 establishes a communication connection with the tag identification device 152. When an animal touches or blocks the infrared beam between the transmitter and the receiver, the infrared beam is interrupted, thereby triggering the tag identification device 152 to operate and detect the animal entering the detection area.

Please refer to FIGS. 1, 3, and 10, The driving mechanism 160 comprises a geared motor 161 and driving wheels 162. The driving wheels 162 abut against the rotating structure 140. The geared motor 161 is used to drive the movement of the driving wheels 162 located on the base 112 to drive the rotation of the rotating structure 140.

During specific implementation: the driving mechanism 160 is arranged on the base 112 of the frame 110. The driving mechanism 160 comprises a geared motor 161 and driving wheels 162. The driving wheel 162 includes, but is not limited to, a friction wheel, gear, or cam. The geared motor 161 is used to drive the movement of the driving wheel 162. A surface of the driving wheel 162 abuts against the movable baffle 141 of the rotating structure 140. The geared motor 161 transmits power to the driving wheel 162, thereby driving the rotation of the rotating structure 140.

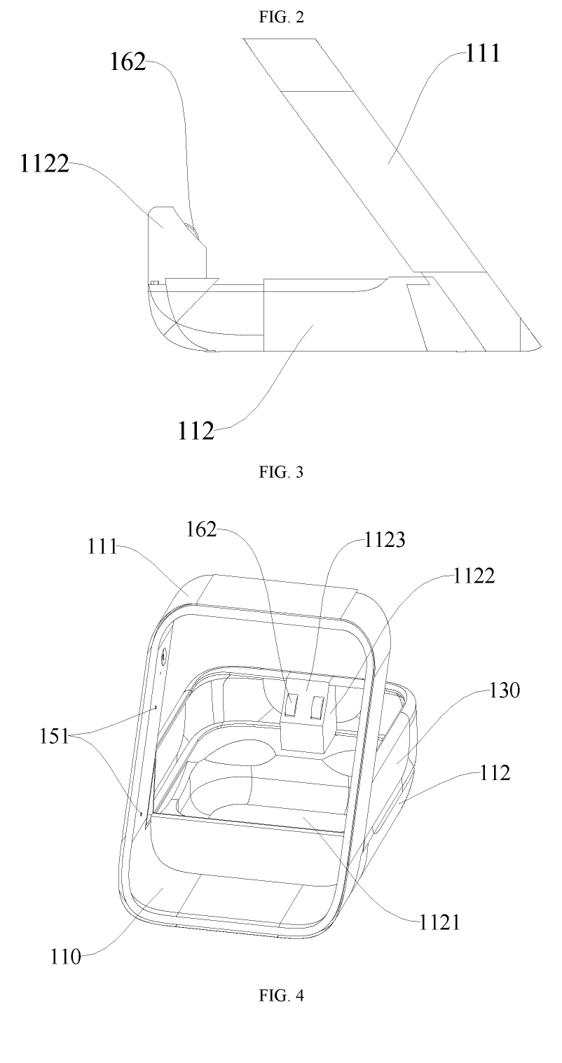

Please refer to FIGS. 2, 3 and 4, The base 112 is provided with a fixing block 1122, the fixing block 1122 is provided with a first inclined surface 1123; the geared motor 161 and the driving wheels 162 are arranged inside the fixing block 1122, the driving wheel 162 protrudes from the first inclined surface 1123 and abuts against the movable baffle 141.

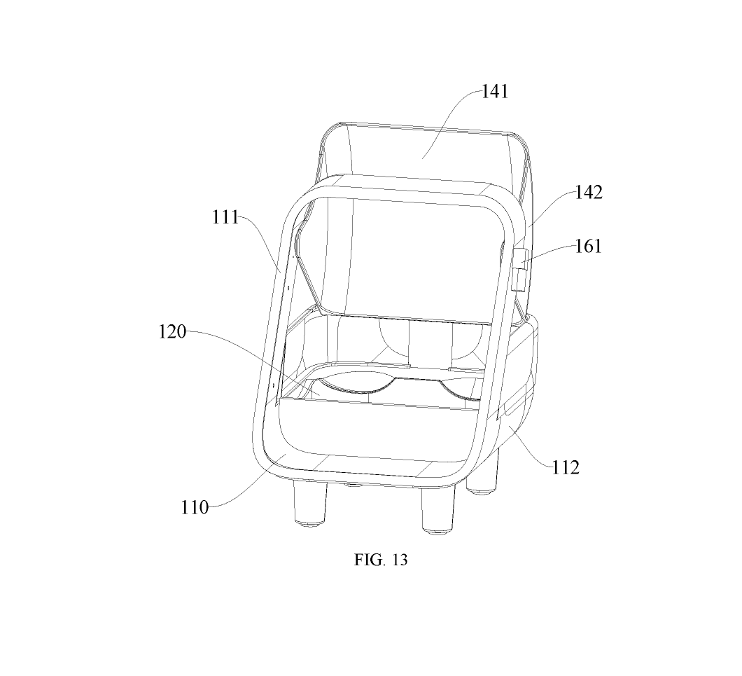

In a specific embodiment, please refer to FIG. 13. The geared motor 161 of the driving mechanism 160 is arranged on the door frame 111, specifically on an outer side of the door frame 111. The geared motor 161 is connected to the rotating shaft 142, so that the geared motor 161 directly transmits power to the rotating shaft 142, which drives the movable baffle 141 to rotate. Arranging the driving mechanism 160 on an outer side of the door frame 111 makes subsequent maintenance and repair of the geared motor 161 more convenient, and reduces the occupation of internal space of the feeder, giving the movable baffle 141 more space for movement when in the open state. At the same time, it avoids potential safety hazards caused by materials entering the driving mechanism 160, reduces the risk of contamination of the geared motor 161, and extends the service life of the geared motor 161.

During specific implementation: one side of the base 112 is provided with a fixing block 1122. Both sides of the fixing block 1122 are connected to the baffle plate 130, and the height of the fixing block 1122 is greater than or equal to the height of the baffle plate 130. The geared motor 161 and the driving wheels 162 are connected and arranged inside the fixing block 1122. The fixing block 1122 is provided with a first inclined surface 1123 on a side close to the placement groove 1121. The driving wheels 162 protrude from the first inclined surface 1123 and abut against the movable baffle 141, so that the geared motor 161 drives the movement of the driving wheels 162, thereby driving the movable baffle 141 to rotate around the rotating shaft 142.

Please refer to FIGS. 11-14 .The invention also provides an animal feeding device, comprising the animal feeder disclosed in the embodiments of the invention.

During specific implementation: an animal feeding device comprises an animal feeder and a food dispensing box 190. A side of the animal feeder away from the door frame 111 abuts against the food dispensing box 190. The baffle plate 130 of the animal feeder is provided with a through hole. As shown in FIG. 12, the food dispensing box 190 is provided with dispensing ports 191. The through hole on the baffle plate 130 abuts against the dispensing port 191 on the food dispensing box 190. A connecting plate is arranged between the through hole and the container 120, and the connecting plate is arc-shaped. The food in the food dispensing box 190 is dispensed into the container 120 in the placement groove 1121 via the connecting plate.

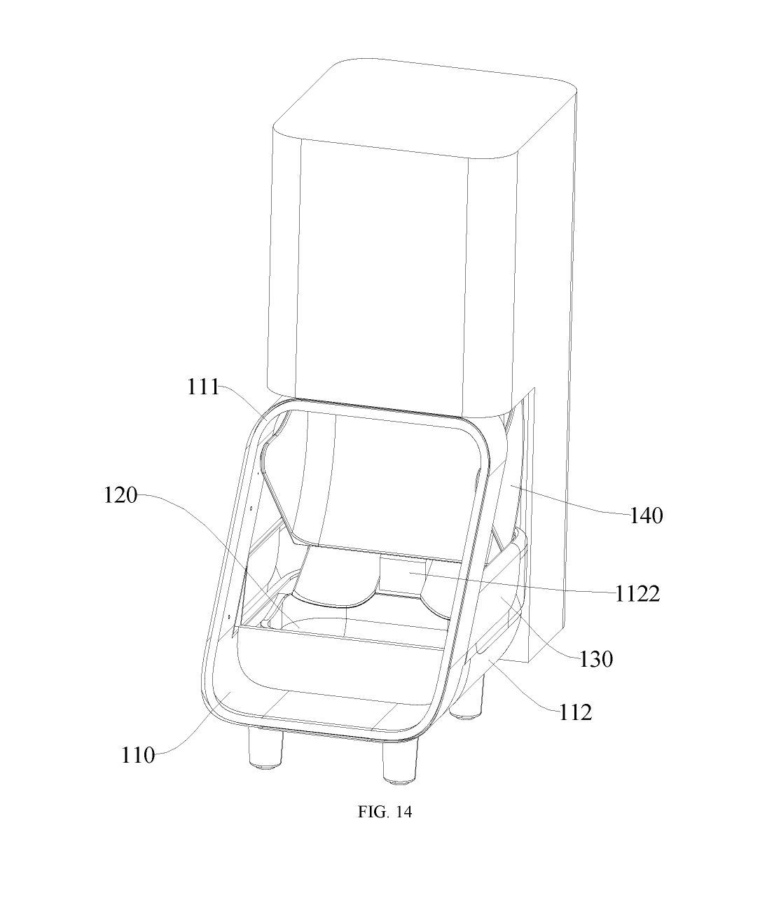

In a specific embodiment, as shown in FIG. 14, the base 112 of the frame 110 is provided with foot pads, and the foot pads are provided with bolts. A bottom of the base 112 is provided with threaded holes. The threaded holes cooperate with the bolts to connect the foot pads to the bottom of the frame 110. The height of the frame 110 can be adjusted by adjusting the degree of cooperation between the threaded holes and the bolts according to actual situations.

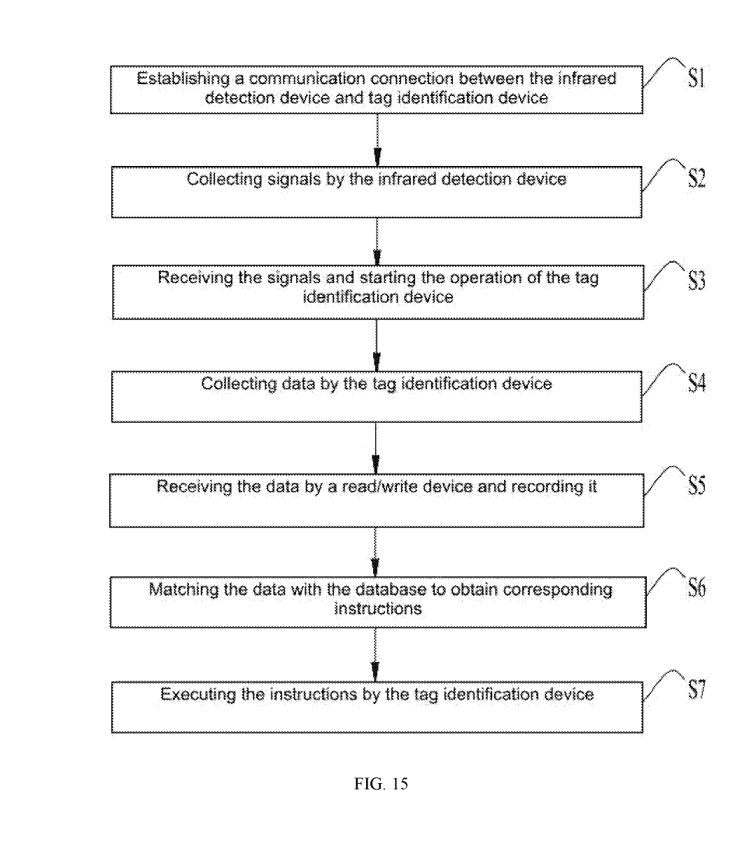

Please refer to FIG. 15. The invention proposes a control method for an animal feeder, comprising:
establishing a communication connection between a preset infrared detection device 151 and a preset tag identification device 152;
collecting signals by the infrared detection device 151;
receiving the signals and starting the operation of the tag identification device 152;
collecting data by the tag identification device 152; wherein the data comprises authorized data, unauthorized data, and blank data;
receiving the data by a preset read/write device and recording it;
matching the data with a preset database to obtain corresponding instructions;
executing the instructions by the tag identification device 152.

During specific implementation: the infrared detection device 151 establishes a communication connection with the tag identification device 152. The infrared detection device 151 comprises a transmitter and a receiver. The transmitting end device emits an infrared beam, and the receiving end device detects the infrared beam emitted by the transmitting end. When an animal passes through the path of the infrared beam between the transmitting end and the receiving end, and the animal blocks part or all of the infrared beam, the receiving end detects this change in infrared beam intensity and thereby determines whether an object is present. The infrared detection device 151 sends the signal of the change in infrared beam intensity to the tag identification device 152, thereby driving the tag identification device 152 to operate.

The tag identification device 152 collects data within the detection area. The data comprises authorized data, unauthorized data, and blank data. The tag information worn by an animal can be written into a preset database by a read/write device. Authorized data is data that matches the database, i.e., tags that have been written into the database. Unauthorized data is data that does not match the database, i.e., tags that have not been written into the database. Blank data is data that cannot be recognized due to environmental factors (such as extreme temperature, humidity) or prolonged use, etc. The coil of the tag identification device 152 communicates with the tag via electromagnetic induction. The coil generates a magnetic field through current. When an animal wearing a tag that has been written into the database enters the magnetic field, the tag receives the radio frequency signal emitted by the coil and sends the information in the tag back to the read/write device through backscattering. The read/write device communicates with the tag worn by the animal. The read/write device compares the read tag information with the tag information written by the read/write device, matches corresponding instructions, and executes the instructions. The tag identification device 152 is electrically connected to the driving mechanism 160. The tag identification device 152 executes the corresponding instructions, thereby driving the operation of the geared motor 161.

In a specific embodiment, in the step of matching the data with a preset database to obtain corresponding instructions, the method comprises:
determining whether the data is consistent with the database;
if yes, matching an opening instruction;
if no, matching a closing instruction.

During specific implementation: the read/write device compares the read tag information with the tag information written by the read/write device into the database, and determines whether the read tag information is consistent with the tag information in the database written by the read/write device;

if the read tag information is consistent with the tag information in the database, i.e., the tag identification device 152 collects authorized data, then an opening instruction is matched. If the read tag information is inconsistent with the tag information in the database, i.e., the tag identification device 152 collects unauthorized data or blank data, then a closing instruction is matched.

In a specific embodiment, the method comprises a first phase and a second phase.

When in the first phase, the infrared detection device 151 collects signals until the signals are interrupted, and then starts the operation of the tag identification device 152;

determining whether the data collected by the tag identification device 152 is consistent with the data in the database;

if yes, matching an opening instruction, and after executing the opening instruction, turning off the tag identification device 152;

if no, turning off the operation of the tag identification device 152.

During specific implementation: when in the first phase, an animal passes through the path of the infrared beam between the transmitter and receiver of the infrared detection device 151, and blocks part or all of the infrared beam. The infrared detection device 151 sends the signal of the change in infrared beam intensity to the tag identification device 152, and drives the tag identification device 152 to operate, detecting the animal entering the detection area of the feeder, obtaining collected data, and determining whether the data is consistent with the data in the database.

If the data collected by the tag identification device 152 is consistent with the data in the database, an opening instruction is matched and executed. At this time, the geared motor 161 of the driving mechanism 160 starts to operate, and through the operation of the driving wheels 162, the movable baffle 141 of the rotating structure 140 moves upward to the open position to ensure that the container 120 is completely open. After executing the opening instruction, the tag identification device 152 is turned off to ensure low-power operation of the feeder.

If the data collected by the tag identification device 152 is inconsistent with the data in the database, the operation of the tag identification device 152 is turned off. At this time, the movable baffle 141 remains in the closed state.

In a specific embodiment, when switching from the first phase to the second phase,

determining whether the signals remain continuously interrupted;

if yes, not turning on the tag identification device 152, and a preset movable baffle 141 remains in the open state;

if no, turning on the tag identification device 152 to operate for a set time;

within the set time, comparing the data collected by the tag identification device 152 with the data in the database;

if the data collected by the tag identification device 152 is consistent with the data in the database, turning off the tag identification device 152, the movable baffle 141 remains in the open state, and simultaneously determining whether the signals become interrupted again;

if yes, the movable baffle 141 remains in the open state;

if no, repeating the detection of the second phase;

if the data collected by the tag identification device 152 is inconsistent with the data in the preset database, matching a closing instruction, and after executing the closing instruction, turning off the tag identification device 152;

when the tag identification device 152 has operated for the set time, matching a closing instruction, and after executing the closing instruction, turning off the operation of the tag identification device 152.

During specific implementation: when in the second phase, the movable baffle 141 remains in the open state, and the infrared beam of the infrared detection device 151 remains continuously interrupted.

Determining whether the signals remain continuously interrupted;

If yes, not turning on the tag identification device 152, and the movable baffle 141 remains in the open state. At this time, it indicates that the animal is feeding.

If no, turning on the tag identification device 152 to operate for a set time.

Within the set time, comparing the data collected by the tag identification device 152 with the data in the database. If the data collected by the tag identification device 152 is consistent with the data in the database, turning off the tag identification device 152. At this time, it indicates that the feeding animal raises its head, causing the infrared beam of the infrared detection device 151 to not be interrupted, i.e., the presence of the animal is not detected, but the animal is still around the feeder and has not left, so the movable baffle 141 remains in the open state. Simultaneously, it is determined whether the signals become interrupted again.

If yes, the movable baffle 141 remains in the open state. At this time, it indicates that the animal continues feeding after raising its head, so the infrared beam of the infrared detection device 151 is interrupted again, and the movable baffle 141 remains in the open state to ensure that the animal can obtain food.

If no, repeating the detection of the second phase, i.e., turning on the tag identification device 152 to operate for a set time.

Within the set time, if the data collected by the tag identification device 152 is inconsistent with the data in the preset database, i.e., within the set time, the animal wearing authorized data leaves the detection area of the tag identification device 152 after being full. The tag identification device 152 does not detect the animal wearing authorized data, and animals wearing unauthorized data or blank data approach the feeder. At this time, the tag identification device 152 matches a closing instruction and executes the closing instruction, causing the movable baffle 141 of the rotating structure 140 to move downward to the closed position, thereby placing the container 120 within the closed space. After executing the closing instruction, the operation of the tag identification device 152 is turned off.

When the tag identification device 152 has operated for the set time, a closing instruction is matched, and after executing the closing instruction, the operation of the tag identification device 152 is turned off. At this time, it indicates that the animal wearing authorized data, after being full, does not leave the detection area of the tag identification device 152 but lingers within the detection area, causing the tag identification device 152 to operate for the set time and then match a closing instruction, and turning off the operation of the tag identification device 152 to wait for the next start.

It should be noted that in this document, the term "comprises", "comprising" or any other variation thereof is intended to cover a non-exclusive inclusion, such that a process, method, article, or apparatus that comprises a list of elements does not include only those elements but may include other elements not expressly listed or inherent to such process, method, article, or apparatus. An element defined by the phrase "comprising a..." does not exclude the presence of additional identical elements in the process, method, article, or apparatus that comprises the element.

The above are only preferred embodiments of this application and are not intended to limit the patent scope of this application. Any equivalent structural or process transformations made based on the contents of the description and drawings of this application, or direct or indirect application in other related technical fields, shall similarly be included within the patent protection scope of this application.

1. An animal feeder, comprising a frame, a container, a baffle plate, a rotating structure, a detection mechanism, and a driving mechanism;
the frame comprises a door frame and a base, the base is connected to the door frame, the base is provided with a placement groove for placing the container;
the baffle plate is arranged corresponding to the base, and the baffle plate is connected to both the base and the door frame, forming a first blocking area with the base;
the rotating structure is arranged on one side of the container and is pivotally connected to the door frame;
the rotating structure comprises an open position and a closed position;
when the rotating structure is in a closed position, the rotating structure forms a closed space with the base and the baffle plate respectively, so that the container is located within the closed space;
when the rotating structure is in a open position, the rotating structure forms a second blocking area with the baffle plate, allowing animals to only contact the container by passing through the door frame;
the detection mechanism is arranged on the frame and is electrically connected to the driving mechanism;
the driving mechanism is arranged inside the frame to drive the rotating structure to move to the open position or the closed position.

2. The animal feeder of claim 1, wherein the rotating structure comprises a movable baffle, a rotating shaft, and a limiting structure, the limiting structure is connected to the rotating shaft, the movable baffle moves around the rotating shaft, and the movable baffle is arc-shaped.

3. The animal feeder of claim 2, wherein when the rotating structure moves to the closed position, the movable baffle moves downward around the rotating shaft, and front and rear edges of the movable baffle respectively coincide with edges of the baffle plate and the base, so that the container is within the closed space;
when the rotating structure moves to the open position, the movable baffle moves upward around the rotating shaft, so that the container is in an open state.

4. The animal feeder of claim 3, wherein the limiting structure at least comprises a first limiting member and a second limiting member, and is used to restrict the movement of the movable baffle.

5. The animal feeder of claim 1, wherein the detection mechanism at least comprises an infrared detection device and a tag identification device, the infrared detection device is arranged on the frame;
the tag identification device is located at a bottom of the frame or on the door frame;
the tag identification device is used to drive the operation of the driving mechanism.

6. The animal feeder of claim 4, wherein the driving mechanism comprises a geared motor and driving wheels; the driving wheels abut against the rotating structure, the geared motor is used to drive the movement of the driving wheels to drive the rotation of the rotating structure.

7. The animal feeder of claim 6, wherein the base is provided with a fixing block, the fixing block is provided with a first inclined surface; the geared motor and the driving wheels are arranged inside the fixing block, the driving wheels protrude from the first inclined surface and abut against the movable baffle.

8. An animal feeding device, comprising the animal feeder disclosed in any claim from claim 1-7.

9. A control method for the animal feeder, comprising:
stablishing a communication connection between a preset infrared detection device and a preset tag identification device;
collecting signals by the infrared detection device;
receiving the signals and starting the operation of the tag identification device;
collecting data by the tag identification device; wherein the data comprises authorized data, unauthorized data, and blank data;
receiving the data by a preset read/write device and recording it;
matching the data with a preset database to obtain corresponding instructions;
executing the instructions by the tag identification device.

10. The control method for the animal feeder of claim 9, wherein in the step of matching the data with a preset database to obtain corresponding instructions, the method comprises:
comparing the data with the database by the read/write device;
determining whether the data is consistent with the database;
if yes, matching an opening instruction;
if no, matching a closing instruction.

11. The control method for the animal feeder of claim 10, wherein the method comprises a first phase and a second phase;
when in the first phase, the infrared detection device collects signals until the signals are interrupted, and then starts the operation of the tag identification device;
determining whether the data collected by the tag identification device is consistent with the data in the database;
if yes, matching an opening instruction, and after executing the opening instruction, turning off the tag identification device;
if no, turning off the operation of the tag identification device.

12. The control method for the animal feeder of claim 11, wherein when switching from the first phase to the second phase,
determining whether the signals remain continuously interrupted;
if yes, not turning on the tag identification device, and a preset movable baffle remains in the open state;
if no, turning on the tag identification device to operate for a set time;
within the set time, comparing the data collected by the tag identification device with the data in the database;
if the data collected by the tag identification device is consistent with the data in the database, turning off the tag identification device, the movable baffle remains in the open state, and simultaneously determining whether the signals become interrupted again;
if yes, the movable baffle remains in the open state;
if no, repeating the detection of the second phase;
if the data collected by the tag identification device is inconsistent with the data in the preset database, matching a closing instruction, and after executing the closing instruction, turning off the tag identification device;
when the tag identification device has operated for the set time, matching a closing instruction, and after executing the closing instruction, turning off the operation of the tag identification device.
